(19) United States
(12) Patent Application Publication
(10) Pub. No.: US 2025/0035202 A1
(43) Pub. Date: Jan. 30, 2025

(54) Belt Actuator System

(71) Applicant: ABB E-mobility B.V., Delft (NL)

(72) Inventors: Luc Picard, Zaventem (BE); Johan Peeters, Korbeel-Lo (BE)

(73) Assignee: ABB E-mobility B.V., Delft (NL)

(21) Appl. No.: 18/785,468

(22) Filed: Jul. 26, 2024

(30) Foreign Application Priority Data
Jul. 28, 2023 (EP) 23188499.0

(51) Int. Cl. F16H 55/30; F16G 13/12; F16G 13/18

(52) U.S. Cl. CPC F16H 55/30; F16G 13/18; F16G 13/12

(57) ABSTRACT

A belt actuator system includes at least a drive unit, a belt zipper system configured to form a third belt element in a zip-fastening manner of a first belt element and a second belt element comprising: a guiding arrangement configured to move the first belt element and the second belt element in a synchronous manner; a first zip-fastening arrangement, wherein the first zip-fastening arrangement is configured to connect a first part of the first belt element with a second part of the second belt element in a zip-like manner to obtain the third zip-fastened belt element, and wherein the drive unit is connected to the first zip-fastening arrangement configured to drive the first zip-fastening arrangement.

### CROSS-REFERENCE TO RELATED APPLICATIONS

The instant application claims priority to European Patent Application No. 23188499.0, filed Jul. 28, 2023, which is incorporated herein in its entirety by reference.

### FIELD OF THE DISCLOSURE

The present disclosure relates to a belt actuator system.

### BACKGROUND OF THE INVENTION

In prior art, usually chains are used to be driven by an actuator system such as a gear that drives the chain and also may further stack the link elements of the chain. Such a chain in combination with a corresponding actuator means may be used to lift or to push a load or drive a rotating element.

In a further application, a chain or to be more general, a movable connecting element may be used by a zipper system to change a position of a tool that is connected to the zipper system via said chain.

However, these chains known in prior art are usually made of metal which makes the chain difficult to handle due to its weight. Also the production of such a chain is difficult and expensive due to a complex production process of connecting the plurality of link elements of such a chain in an end-to-end manner. Further, the application of a chain is such a zipper system to lift items is often accompanied with additional efforts for maintenance the chains, e.g. providing lubrication means such as oil, to ensure that the chain is working smoothly during a production task. This makes the use of such a zipper system susceptible to regular maintenance and thus, complex and expensive when used in a production process.

### BRIEF SUMMARY OF THE INVENTION

Therefore, it would be advantageous to provide an improved concept for a belt actuator system that can be manufactured in an easy and cost-efficient manner and that is further easy to adaptable for different applications and which can be operated at low-costs.

In a first aspect of the present invention, there is provided a belt actuator comprising: at least a drive unit, a belt zipper system configured to form a third belt element in a zip-fastening manner of a first belt element and a second belt element comprising: a guiding arrangement configured to move the first belt element and the second belt element in a synchronous manner: a first zip-fastening arrangement, wherein the first zip-fastening arrangement is configured to connect a first part of the first belt element with a second part of the second belt element in a zip-like manner to obtain the third zip-fastened belt element, and wherein the drive unit is connected to the first zip-fastening arrangement configured to drive the first zip-fastening arrangement.

One important aspect of the belt actuator system comprising the belt zipper system is that the same coils are used for zipper and storing the third belt element (“zipper”) and further that only a single motor is needed for actuation as well as for storing the third belt element. This makes the belt zipper system simple, as only one single motor is needed to zip or put together the belt elements. Each of the belt elements having grooves to align the two interconnecting belt elements in a zip-fastening arrangement. The same single motor is also used to unzip the third belt element which rests the belt in a spiral manner occupying only a minimum of space with a constant velocity.

### BRIEF DESCRIPTION OF THE SEVERAL VIEWS OF THE DRAWING(S)

FIG. 1 is an exemplary schematic of a belt actuator system with a belt zipper system according to an embodiment of the present disclosure.

FIG. 2 is an exemplary schematic of a belt actuator system with a belt zipper system according to an embodiment of the present disclosure.

FIGS. 3A and 3B illustrate a coil from a front and side perspective, respectively, of the belt zipper system in a perspective view according to an embodiment of the present disclosure.

FIG. 4 is a sectional view of a coil of a belt actuator system with a belt zipper system according to an embodiment of the present disclosure.

FIG. 5A is a schematic of an example of a belt actuator system with a belt zipper system according to an embodiment of the present disclosure.

FIG. 5B is a schematic of an example of a belt actuator system with a belt zipper system according to an embodiment of the present disclosure.

FIG. 5C is a schematic of an example of a belt actuator system with a belt zipper system according to an embodiment of the present disclosure.

FIG. 5D is a schematic of an example of a belt actuator system with a belt zipper system according to an embodiment of the present disclosure.

FIG. 5E is a schematic of an example of a belt actuator system with a belt zipper system according to an embodiment of the present disclosure.

FIG. 6 is a schematic of an example of a winded belt according to an embodiment of the present disclosure.

### DETAILED DESCRIPTION OF THE INVENTION

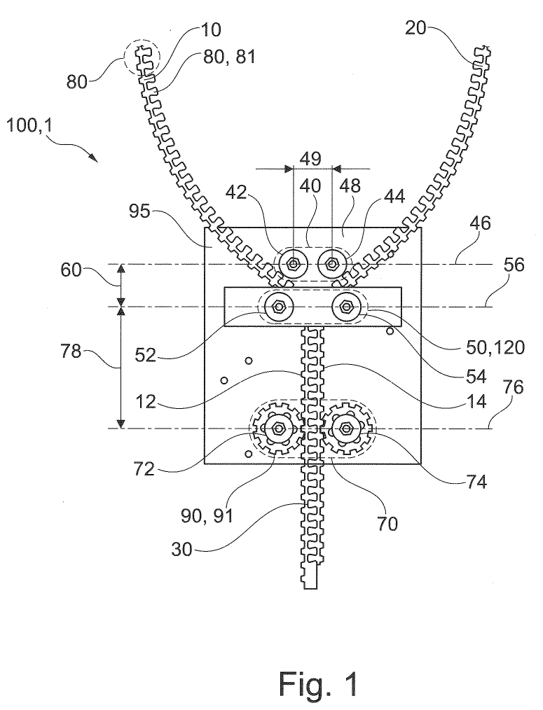

FIG. 1 illustrates a schematic example of a belt actuator system 100 with a belt zipper system 1 according to an embodiment of the present invention. The belt zipper system 1 is configured to form a third belt element 30 in a zip-fastening manner of a first belt element 10 and a second belt element 20. The belt zipper system 1 comprises a guiding arrangement 40, 42, 44 comprising a first movable guiding element 42 and at least a second movable guiding element 44 arranged in a same first plane 46 configured to move the first belt element 10 and the second belt element 20 in a synchronous manner.

According to FIG. 1, the guiding arrangement 40, 42, 44 in FIG. 1 comprises an actuating unit 48 to move the first guiding element 42 and/or the second guiding element 44 of the guiding arrangement 40. The belt zipper system 1 further comprises a first zip-fastening arrangement 50 comprising a first movable coil 52 and a second movable coil 54 arranged in a same second plane 56, wherein the first zip-fastening arrangement 50 is configured to connect a first part 12 of the first belt element 10 with a second part 14 of the second belt element 20 in a zip-like manner to obtain the third zip-fastened belt element 30.

In this respect, it should be noted that alternatively, the belt actuator system 100 may comprise a drive unit 120 to drive the first zip-fastening arrangement 50 and its corresponding coils 52, 54 instead of the actuating unit 48.

Further, in an example, the drive unit 120 is connected to the first zip-fastening arrangement 50 configured to drive the first zip-fastening arrangement 50 and/or is connected to the second zip-fastening arrangement 70 configured to drive the second zip-fastening arrangement 70.

The drive unit 120 may comprise a single motor or a plurality of motors (not shown in FIG. 1). In the belt zipper system 1, the first plane 46 of the guiding arrangement 40, 42, 44 is positioned in a defined first distance 60 to the second plane 56 of the first zip-fastening arrangement 50, 52, 54.

Optionally, the defined first distance 60 of the first plane 46 of the guiding arrangement 40, 42, 44 related to the second plane 56 of the first zip-fastening arrangement 50 in a defined horizontal and/or vertical direction.

According to FIG. 1, the belt zipper system 1 comprises a second zip-fastening arrangement 70 comprising a third movable coil 72 and a fourth movable coil 74 arranged in a same third plane 76, wherein the third plane 76 is arranged in a second horizontal distance 78 to the second plane 56 of the first zip-fastening arrangement 50.

As the FIG. 1 shows, the first guiding element 42 and at least a second guiding element 44 of the guiding arrangement 40 have a defined distance 49 in horizontal direction of the first plane 46.

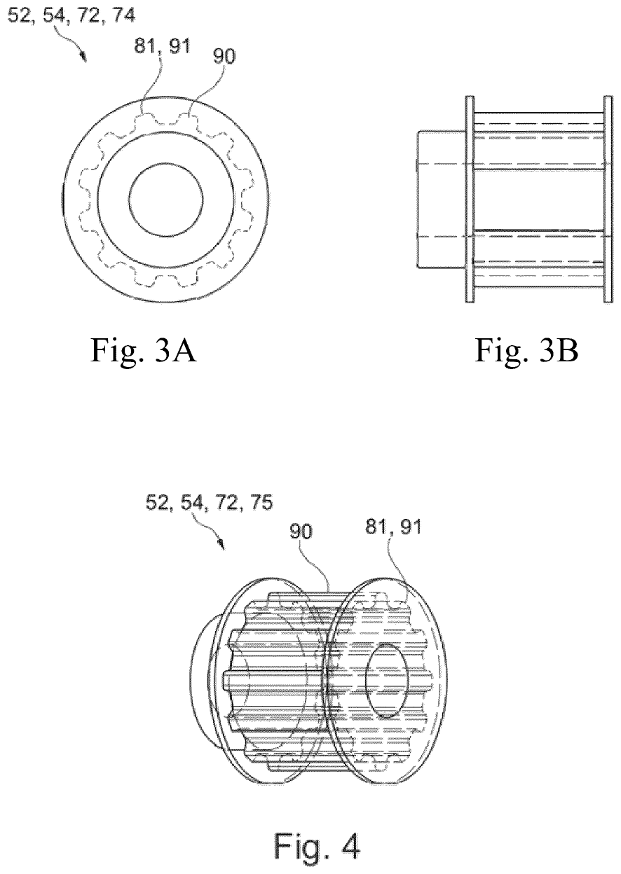

According to FIG. 1, the belt elements 10, 20 comprise a belt surface 80 having a plurality of tooth-like form elements 81. According to FIG. 1 in combination with FIGS. 3A and 3B, and 4, the coils 52, 72, 74 of the two zip-fastening arrangements 50, 70 comprise each a coil surface 90 having a plurality of tooth-like form elements 91 that is identical to the belt surface 80 of the belt elements 10, 20.

According to a further and more detailed example of the belt actuator system 100 and as shown in FIG. 1, the belt actuator system 100 comprises at least a drive unit 120 and a belt zipper system 1 configured to form a third belt element 30 in a zip-fastening manner of a first belt element 10 and a second belt element 20.

The belt zipper system 1 further comprises:
a guiding arrangement 40, 42, 44 comprising a first movable guiding element 42 and at least a second movable guiding element 44 arranged in a same first plane 46 configured to move the first belt element 10 and the second belt element 20 in a synchronous manner:
a first zip-fastening arrangement 50 comprising a first movable coil 52 and a second movable coil 54 arranged in a same second plane 56, wherein the first zip-fastening arrangement 50 is configured to connect a first part 12 of the first belt element 10 with a second part 14 of the second belt element 20 in a zip-like manner to obtain the third zip-fastened belt element 30, and
wherein the first plane 46 of the guiding arrangement 40, 42, 44 is positioned in a defined first distance 60 to the second plane 56 of the first zip-fastening arrangement 50,
a second zip-fastening arrangement 70 comprising a third movable coil 72 and a fourth movable coil 74 arranged in a same third plane 76, wherein the third plane 76 is arranged in a second horizontal distance 78 to the second plane 56 of the first zip-fastening arrangement 50,
wherein the drive unit 120 is connected to the first zip-fastening arrangement 50 configured to drive the first zip-fastening arrangement 50 and/or is connected to the second zip-fastening arrangement 70 configured to drive the second zip-fastening arrangement 70.

According to FIG. 1, the actuating unit 48 is a motor enabling to move the both belt elements 10, 20 preferably in synchronous or synchronized manner.

The belt elements 10, 20 may preferably of a same material and preferably of a flexible plastic material.

In this context, it should be noted that the loose ends of the belt may be winded up by using a preferred system, e.g. actively-driven or passive system (not shown in the figures). The winding of the belt ends may be done in a same plane or in a different plane. In this respect, FIG. 6 shows an example for belts that are winded up.

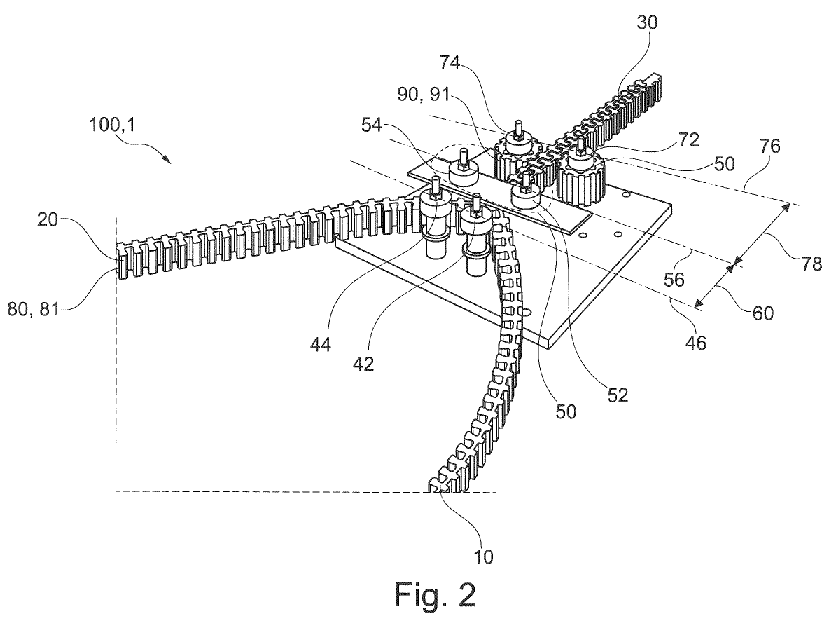

FIG. 2 illustrates a schematic example of a belt actuator system 100 with a belt zipper system 1 according to an embodiment of the present invention. In principle, the embodiment of FIG. 2 shows the same belt zipper system 1 of FIG. 1 only in another perspective view without the drive unit 120 and the actuating unit 48.

FIG. 4 illustrates a sectional view of a coil 52, 54, 72, 74 of a belt zipper system according to an embodiment of the present invention. The coil 52, 54, 72, 74 has a coil surface 90 which is configured to have cavities in which the tooth-like form element 81, 91 of the belt element 10, 20 is positioned accordingly.

FIGS. 3A and 3B illustrate a coil 52, 54, 72, 74 of the belt zipper system 1 having a coil surface 90 in a perspective view according to an embodiment of the present disclosure, from a front (FIG. 3A) and side perspective (FIG. 3B).

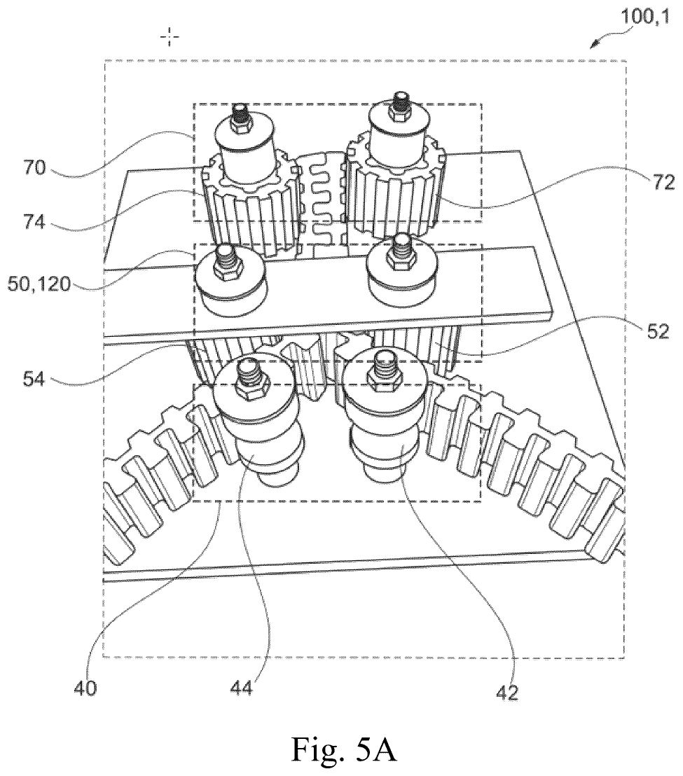

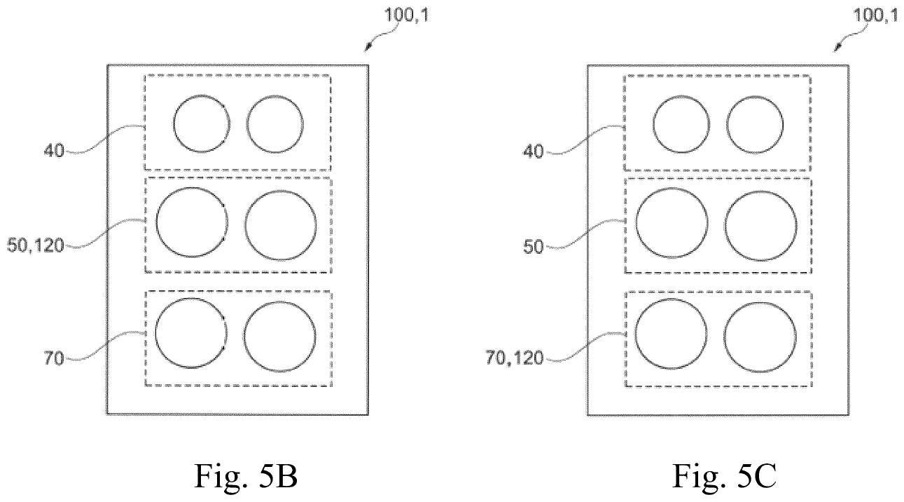

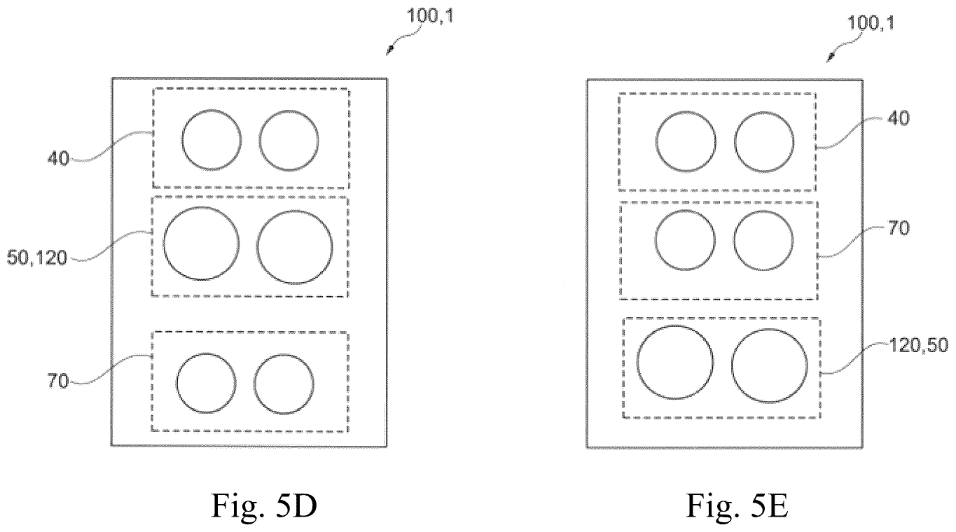

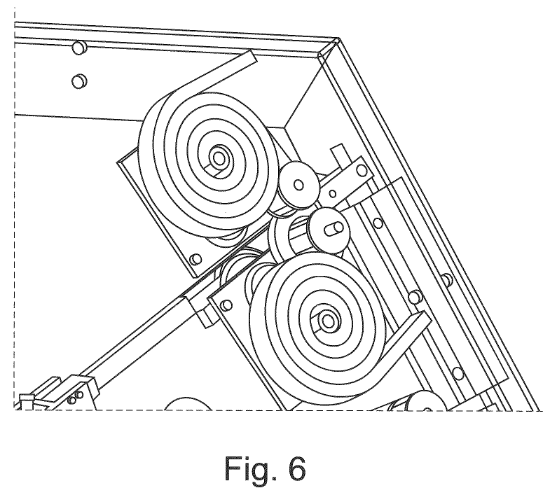

FIG. 5A illustrates a schematic example of a belt actuator system 100 with a belt zipper system 1 according to an embodiment of the present invention. In principle, the belt actuator system 100 is identical to the embodiment shown in FIG. 1. However, in the embodiment of FIG. 5A, no actuating unit 48 is inserted. Instead, as a further example, a drive unit 120 is implemented driving the first zip-fastening-arrangement 50. The drive unit 120 may comprise a single motor or a plurality of motors to either drive one coil or to drive both coils of the two coils 52, 54. Hence, the coils 52, 54 may embodied as traction gears which are connected to a motor for example.

The motor used for traction gears may be a stepper motor providing the functionality of back-drivability of the system or/and may be a DC motor not providing the functionality of back-drivability of the system.

For the following FIGS. 5B to 5E, it is noted that for ease of understanding, the corresponding coils 42, 44 of the guiding arrangement 40, the coils 52, 54 of the first zip-fastening arrangement 50 and the coils 72, 74 of the second zip-fastening arrangement 70 as shown in FIGS. 1, 2 and 5A are not depicted in the FIGS. 5A to 5E.

FIG. 5B illustrates a schematic example of a belt actuator system 100 with a belt zipper system 1 according to an embodiment of the present disclosure. In this embodiment, the drive unit 120 is configured to actively drive coils 52, 54 of the first zip-fastening arrangement 50. The drive unit 120 may be configured as one or more traction gear elements connected to one or more motors (not shown). The coils 42, 44 of the guiding arrangement 40 are configured as passive rollers or fix guides. The coils 72, 74 of the second zip-fastening arrangement 70 are configured as passive traction gear elements not connected to a motor.

FIG. 5C illustrates a further schematic example of a belt actuator system 100 with a belt zipper system 1 according to an embodiment of the present disclosure. In this embodiment, the drive unit 120 is configured to actively drive coils 72, 74 of the second zip-fastening arrangement 70 and is embodied as a traction gear element connected to a motor unit (not shown). The coils 42, 44 of the guiding arrangement 40 are configured as passive rollers or fix guides and the coils 52, 54 of the first zip-fastening arrangement 50 are configured as passive traction gear elements not connected to a motor.

FIG. 5D illustrates a schematic example of a belt actuator system 100 with a belt zipper system 1 according to an embodiment of the present disclosure. In this embodiment, the drive unit 120 is configured to actively drive coils 52, 54 of the first zip-fastening arrangement 50. The drive unit 120 may be configured as traction gear elements connected to one or more motors (not shown). The coils 42, 44 of the guiding arrangement 40 and the coils 72, 74 of the second zip-fastening arrangement 70 are configured as passive rollers or fix guides.

FIG. 5E illustrates a further schematic example of a belt actuator system 100 with a belt zipper system 1 according to an embodiment of the present disclosure. In this embodiment, the drive unit 120 is configured to actively drive coils 52, 54 of the first zip-fastening arrangement 50. The drive unit 120 may be configured as traction gear elements connected to one or more motors (not shown) to drive the coils 52, 54 of the first zip-fastening arrangement 50. The coils 42, 44 of the guiding arrangement 40 and the coils 72, 74 of the second zip-fastening arrangement 70 are configured as passive rollers or fix guides.

In regard of the embodiments of FIGS. 5B, 5C, 5D, and 5E, it should be further noted that the diameter of the passive rollers or fix guides can be of any size that is suitable for the chosen application.

The drive unit is configured to drive the coils of the first zip-fastening arrangement and/or the second zip-fastening arrangement.

A further advantageous aspect of the present invention is that the belt of the belt zipper system is driven by an actuator motor in an active way.

No springs are needed for the belt actuator system. This makes the belt zipper system very simple to build provide an effective design and a belt zipper system that is easy to maintain, as the belt elements of the belt zipper system do not need any lubrication system to be maintained compared with metal chain elements as usually known in prior art for zipper systems. The gearing of the belt zipper system is selected accordingly, so that a full zipper is achieved when the actuator is in a retracted position.

When the two belt elements are rolled into each other in a zipped-like manner to form the third resulting belt element, the final or composed belt element becomes very stiff and can be used for example in an actuator system as connecting means or force transmitting means to drive or to move for example a tool that is connected to the belt zipper system.

As the belt elements used by the belt zipper system are made of one single material, the manufacturing of the belt elements and the belt zipper system in total is easy and cost-efficient.

A further advantage of the belt zipper system can be easily adapted to different fields of applications.

According to an example, the defined first distance of the first plane of the guiding arrangement related to the second plane of the first zip-fastening arrangement in a defined horizontal and/or vertical direction. In this way, the belt zipper system can be produced in a very simple design that makes the belt zipper system cost-efficient.

According to an example, the guiding arrangement comprises an actuating unit to move the first guiding element and/or the second guiding element of the guiding arrangement. In this way, an efficiently driveable belt zipper system is provided.

According to an example, the first guiding element and at least a second guiding element of the guiding arrangement have a defined distance in horizontal direction of the first plane. In this way, the belt zipper system can be easily adapted to different applications.

According to an example, the belt elements comprise a belt surface having a plurality of tooth-like form elements. In this way, a zip-fastening arrangement for the belt zipper system can be easily provided that interconnects the belt elements in smooth and easy manner.

According to an example, the coils of the two zip-fastening arrangements comprise each a coil surface having a plurality of tooth-like form elements that is identical to the belt surface of the belt elements. In this way, a zip-fastening arrangement for the belt zipper system can be easily provided that interconnects the belt elements in smooth, fixed and synchronized manner.

According to an example, the actuating unit is a motor enabling to move the both belt elements in synchronous manner. In this way, an efficiently driveable belt zipper system is provided.

According to an example, the belt elements are of a same material. In this way, the belt zipper system is simple and cost-efficient to build and does not require large maintenance.

In a second aspect of the invention, a belt system is provided comprising a belt zipper system according to the first aspect.

In a further aspect of the present invention, there is provided a belt actuator comprising: at least a drive unit, a belt zipper system, configured to form a third belt element in a zip-fastening manner of a first belt element and a second belt element, comprising: a guiding arrangement comprising a first movable guiding element and at least a second movable guiding element arranged in a same first plane configured to move the first belt element and the second belt element in a synchronous manner: a first zip-fastening arrangement comprising a first movable coil and a second movable coil arranged in a same second plane, wherein the first zip-fastening arrangement is configured to connect a first part of the first belt element with a second part of the second belt element in a zip-like manner to obtain the third zip-fastened belt element, and wherein the first plane of the guiding arrangement is positioned in a defined first distance to the second plane of the first zip-fastening arrangement, a second zip-fastening arrangement comprising a third movable coil and a fourth movable coil arranged in a same third plane wherein the third plane is arranged in a second horizontal distance to the second plane of the first zip-fastening arrangement; wherein the drive unit is connected to the first zip-fastening arrangement and/or is connected to the second zip-fastening arrangement.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising.” “having.” “including.” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 Belt zipper system
10 First belt element
12 First part
14 Second part
20 Second belt element
22 First guiding element
24 Second guiding element
30 Third belt element
40 Guiding arrangement
42 First guiding element
44 Second guiding element
46 First plane
48 Actuating unit
49 Distance between guiding elements
50 First zip-fastening arrangement
52 First coil 52
54 Second coil
56 Second plane
60 First distance
70 Second zip-fastening arrangement
72 Third coil
74 Fourth coil
76 Third plane
78 Second distance
80 Belt surface
81, 91 Tooth-like form element of the belt element
90 Coil surface
95 Platform
120 Drive unit

What is claimed is:

1. A belt actuator system, comprising:
at least a drive unit;
a belt zipper system configured to form a third belt element in a zip-fastening manner of a first belt element and a second belt element (20) comprising:
a guiding arrangement configured to move the first belt element and the second belt element in a synchronous manner;
a first zip-fastening arrangement, wherein the first zip-fastening arrangement is configured to connect a first part of the first belt element with a second part of the second belt element in a zip-like manner to obtain the third zip-fastened belt element, and
wherein the drive unit is connected to the first zip-fastening arrangement configured to drive the first zip-fastening arrangement.

2. The belt actuator system according to claim 1, wherein the defined first distance of the first plane of the guiding arrangement related to the second plane of the first zip-fastening arrangement in a defined horizontal and/or vertical direction.

3. The belt actuator system according to claim 1, wherein the guiding arrangement comprises an actuating unit to move the first guiding element and/or the second guiding element of the guiding arrangement.

4. The belt actuator system according to claim 1, wherein the first guiding element and at least a second guiding element of the guiding arrangement have a defined distance in horizontal direction of the first plane.

5. The belt actuator system according to claim 1, wherein the belt elements comprise a belt surface having a plurality of tooth-like form elements.

6. The belt actuator system according to claim 1, wherein the coils of the first zip-fastening arrangement comprises each a coil surface having a plurality of tooth-like form elements that is identical to the belt surface of the belt elements.

7. The belt actuator system according to claim 1, wherein the actuating unit is a motor enabling to move the both belt elements in synchronous manner.

8. The belt actuator system according to claim 1, wherein the belt elements are made of a same material.
